(19) United States
(12) Patent Application Publication
(10) Pub. No.: US 2017/0132467 A1
(43) Pub. Date: May 11, 2017

(54) METHOD FOR PERSONAL IDENTIFICATION

(71) Applicant: Robert Bosch GmbH, Stuttgart (DE)

(72) Inventor: Hoang Trinh, Gerlingen (DE)

(21) Appl. No.: 15/319,019

(22) PCT Filed: Apr. 21, 2015
(86) PCT No.: PCT/EP2015/058572

§ 371 Date: Dec. 15, 2016

(30) Foreign Application Priority Data
Jun. 20, 2014 (DE) 10 2014 211 823.9

(51) Int. Cl. G06K 9/00; G06K 9/20; G06T 7/70

(52) U.S. Cl. CPC G06K 9/00617; G06T 7/70; G06K 9/00832; G06K 9/0061; G06K 9/2027; G06K 9/00892; G06K 9/00604; G06T 2207/30196

(57) ABSTRACT

In a method for personal identification, a person is recognized in camera-based fashion, a person being positively identified only if the eye position of the person is identified in a viewing-direction recognition unit.

### FIELD

The present invention relates to a method for personal identification, for example, as driving-authorization control in a vehicle or as access control for a building.

### BACKGROUND INFORMATION

Conventional video-based personal-identification systems are used for access control for buildings, and via a video camera, compare the image taken of a person to a stored reference image. If the image photographed agrees with the reference image in a number of features, access is granted.

However, such personal identification systems have the danger of misuse, for example, by holding a photo of an authorized person in the viewing field of the camera, so that the person is identified solely on the basis of an image, and not on the basis of a real person.

### SUMMARY

An object of the present invention is to identify a person using simple measures, in doing which, the danger of misuse being reduced.

This objective is achieved according to the present invention by the features set forth in the independent claims. The dependent claims delineate useful further refinements.

A first aspect of the present invention relates to a method for personal identification in order, for example, to implement an access control specific to the individual, e.g., in a vehicle as driving authorization or as access control to buildings. The method presumes, first of all, a camera-based personal recognition, and secondly, the recognition of the eye position of the person with the aid of a viewing-direction recognition unit. The recognition of the eye position allows a positive personal identification and rules out cases of misuse in which attempt is made to identify a person solely on the basis of images of the actually authorized person. In the method of the present invention, a person is identified positively only when, in addition to recognition via the camera, the eye position is also determined, which is only the case if an actual person, and not just an image of a person, is standing before the personal identification system and is supposed to be recognized.

The viewing-direction signal generated in response to detected eye position is thus used to differentiate between an image of a person and a real person, thereby significantly reducing the danger of misuse. If a person is positively identified, it may be assumed that the person recognized in a camera system is actually the real authorized person.

A further aspect of the present invention relates to a method for personal identification, which likewise may be used, for example, in a vehicle as driving authorization control or as access control to a building or the like. In this method, in a first step, the viewing direction of the person is determined with the aid of a viewing-direction recognition unit, and subsequently, in a second step, based on the recognized viewing direction, a search window is determined, within which a camera-based personal identification is carried out. In this case, the viewing-direction recognition unit has the function of defining and narrowing the search window, within which the optical personal identification is carried out via the camera-based system. This reduces the search area significantly, and helps to increase reliability in the personal identification and to reduce the danger of misuse.

If desired, the aforementioned aspects of the present invention may also be combined with each other, both by utilizing the detection of the viewing direction for determining the search window for the camera-based personal identification, and by using the signal, generated in the viewing-direction recognition unit in response to detected eye position, as confirmation that the person identified in the camera system is a real person and not an image.

According to one advantageous embodiment, an infrared camera is used as viewing-direction recognition unit. In addition to the infrared camera, the viewing-direction recognition unit preferably also includes an infrared illumination unit via which infrared rays, especially in the near infrared range, are emitted in the direction of the person to be identified. In doing this, a characteristic highlight is produced on the cornea in the area of the pupil of the eye of the person to be identified, as the eye reflects the infrared light like a convex mirror (corneal reflection). The highlight on the cornea is visible in the image recorded by the infrared camera, whereupon a signal identifying the eye position may be generated, which may be utilized for the positive personal identification. The camera image may be subjected to further image-processing steps, such as feature extraction, a detection and a determination of the center of the pupil for determining the viewing direction.

Basically, the reflection of a spot of light on the cornea of the eye may also be produced with visible light. Accordingly, a camera operating in visible light may be used.

In general, it is expedient that the viewing-direction recognition unit includes an illumination unit, via which rays are emitted in the direction of the head of the person. In the illumination unit, rays are generated in the infrared range or in the visible range, that are detected via an infrared camera or an optical camera of the viewing-direction recognition unit and evaluated. If rays are generated in the near infrared range, the associated infrared camera may also be utilized for the personal identification. The illumination unit is in a defined position relative to the associated camera, so that the geometry of the beam path between illumination unit, eye and camera is known. For example, it may be expedient to mount the illumination unit fixedly on the camera. However, designs are also advantageous in which the illumination unit is not retained on the camera, but rather is disposed separately from the camera, preferably with distance to the camera, for example, to generate desired light effects.

Moreover, it may be advantageous to use at least two viewing-direction recognition units, making it possible to detect the head of the person from different directions. Correspondingly, the eye position or the viewing direction may also be detected in the case of different head positions. The use of several viewing-direction recognition units provides greater certainty and reliability in the personal identification.

Optionally, it may be advantageous to use information from further sensors for the personal identification, for example, signals of a voice sensor or a thermal image sensor, in order to improve recognition performance in the identification.

In addition, one aspect of the present invention relates to a personal identification system, with which a method for personal identification may be carried out. The personal identification system includes a camera system for optical person recognition, as well as a viewing-direction recognition unit for recognizing the eye position and/or the viewing direction of a person. For example, the personal identification system is used in a vehicle for driving authorization control or buildings as access control. The camera system allows the identification of the person; the viewing-direction recognition unit allows either a confirmation of the identified person in order to improve recognition reliability and/or a selection or determination of the search window which is observed by the camera system. In the last-named case, designs are possible both in which a camera of the camera system is permanently installed, and within the image recorded, a section is defined that is examined, as well as a camera system having a movable camera which is adjusted via an actuator and is able to be directed toward the respective search window.

The viewing-direction recognition unit may include an illumination unit, with which either light in the visible range or rays in the infrared range are generated. The light or the rays are directed toward the head of the person to be identified, and are reflected by the cornea in the eye of the person. A camera as component of the viewing-direction recognition unit is able to pick up the reflected light or the infrared rays, which are subsequently subjected to image processing in order to determine at least the eye position, and possibly the viewing direction of the person.

Further advantages and useful implementations may be gathered from the description herein, and the figures, in which a personal identification system is represented in schematic fashion.

### BRIEF DESCRIPTION OF THE DRAWING

FIG. 1 shows an example personal identification system.

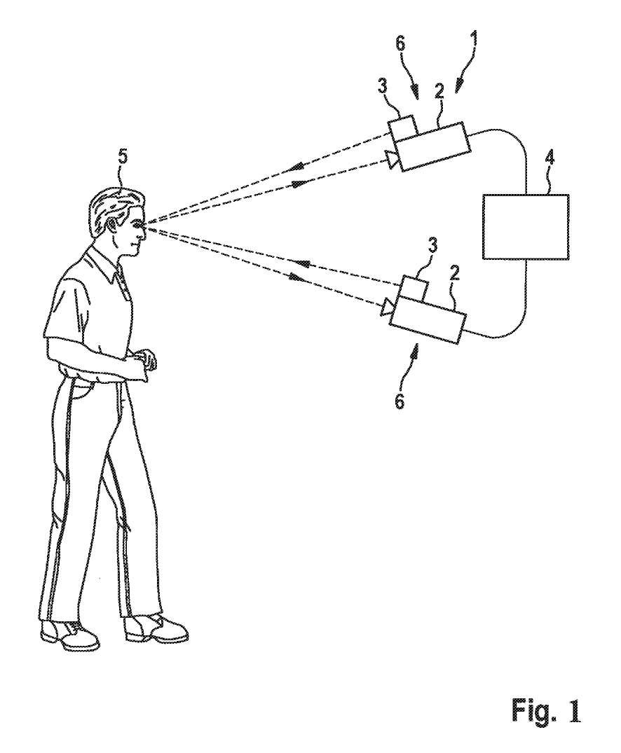

### DETAILED DESCRIPTION OF EXAMPLE EMBODIMENTS

Personal identification system 1 includes two cameras 2, each of which is assigned an illumination unit 3, as well as an arithmetic logic unit 4 for evaluating the data and signals received. The two cameras 2 and assigned illumination units 3, in extension of their axes, have an intersection in which head 5 of a person to be identified is located. For example, personal identification system 1 may be employed as driving authorization control in a vehicle or as access control to a building.

Advantageously, both cameras 2 are identical; for example, cameras 2 are infrared cameras or video cameras. Illumination units 3 are also expediently identical; in each case they may be implemented as an infrared illumination unit, preferably in the near infrared range, or possibly as an illumination unit in the visible light range. Each camera 2 belongs to a camera system; in addition, each camera, together with illumination unit 3, forms a viewing-direction recognition unit 6. Arithmetic logic unit 4 is thus assigned both to each camera system and to each viewing-direction recognition unit 6.

Infrared rays are directed via illumination unit 3 toward head 5 of the person to be identified, the infrared rays being reflected by the cornea of the eye, and the reflected infrared light being recorded as characteristic reflection or as highlight in the image of camera 2. Therefore, in a first step, the eye position of the person may be identified via an evaluation in arithmetic logic unit 4.

The personal identification is accomplished via the image of the face which is photographed by each camera 2. In so doing, characteristic features of the photographed image are compared to a stored reference image.

A positive personal identification exists for the case when both the comparison of the image of the photographed face with a stored reference image yields a match, and the eye position has been identified in at least one camera 2. For this case, a real person may be assumed, and a misuse attempt, e.g., with the aid of an image of a person held in the camera region, may be ruled out.

In addition, from the identified eye position, it is possible to determine the viewing direction of the person, which may be utilized for ascertaining the search window or evaluation window for each camera 2. In this way, the area to be examined is restricted.

Optionally, via locally distributed cameras 2, it is possible to determine characteristic reflections at the left and the right eye simultaneously, which first of all, leads to better confirmation of the personal identification associated with greater surety, and secondly, further restricts the search window which is examined for the personal identification.

If it is determined with sufficient certainty in arithmetic logic unit 4 that the person is access-authorized, a corresponding signal for the positive personal identification is generated, which optionally, may be further processed in another arithmetic logic unit, e.g., in a vehicle for the driving authorization or in a locking system in a building for the access authorization.

1-10. (canceled)

11. A method for personal identification, comprising:
recognizing a person in camera-based fashion, the person being positively identified only if an eye position of the person is identified in a viewing-direction recognition unit.

12. The method as recited in claim 11, wherein the method is performed in a vehicle.

13. The method as recited in claim 11, wherein the viewing direction of the person is recognized with the aid of the viewing-direction recognition unit, and the recognized viewing direction is utilized to determine a search window for a camera-based personal identification.

14. The method as recited in claim 11, wherein an illumination unit, with which the head of the person is irradiated, is used in the viewing-direction recognition unit.

15. The method as recited in claim 11, wherein one shared camera is used for the viewing-direction recognition unit and for a camera system for the personal identification.

16. The method as recited in claim 11, wherein at least one of: i) at least two viewing-direction recognition units are used, and ii) at least two camera systems are used.

17. A personal identification system, comprising:
a camera system for optical person recognition; and
a viewing-direction recognition unit for recognizing at least one of an eye position and a viewing direction of a person.

18. The personal identification system as recited in claim 17, wherein the viewing-direction recognition unit includes an infrared illumination unit.

19. The personal identification system as recited in claim 17, wherein the viewing-direction recognition unit and the camera system for the personal identification use one and the same camera.

20. The personal identification system as recited in claim 17, wherein the system includes at least one of: i) at least two viewing-direction recognition units are provided, and ii) at least two camera systems are provided.

21. The personal identification system as recited in claim 17, wherein at least one additional sensor for person recognition is provided, the sensor including one of a voice sensor or a thermal image sensor.
